(19) United States
(12) Patent Application Publication
(10) Pub. No.: US 2025/0303868 A1
(43) Pub. Date: Oct. 2, 2025

(54) ENGINE COMPARTMENT STRUCTURE FOR VEHICLE

(71) Applicant: TOYOTA JIDOSHA KABUSHIKI KAISHA, Toyota-shi (JP)

(72) Inventor: Takahiro NAKAJIMA, Toyota-shi (JP)

(73) Assignee: TOYOTA JIDOSHA KABUSHIKI KAISHA, Toyota-shi (JP)

(21) Appl. No.: 19/058,181

(22) Filed: Feb. 20, 2025

(30) Foreign Application Priority Data
Apr. 1, 2024 (JP) 2024-059183

(51) Int. Cl. B60K 37/20; B60K 11/02; B60K 13/04; F01M 11/02; F01N 3/20; F01N 13/08; F01P 3/20

(52) U.S. Cl. CPC B60K 37/20; B60K 11/02; B60K 13/04; F01M 11/02; F01N 3/2013; F01N 13/08; F01P 3/20

(57) ABSTRACT

An engine compartment structure for a vehicle includes an engine, a dashboard panel that separates an engine compartment and a passenger compartment from each other, an exhaust pipe that extends from the engine toward the dashboard panel, and a heating device in which a flow passage is defined. A heating medium flows through the flow passage. A part of the exhaust pipe between the engine and the dashboard panel is formed by an electrically heated catalyst device in which a catalyst is supported by a catalyst support that generates heat when energized. The heating device is located between the engine and the dashboard panel. A part of an outer surface of the heating device faces an outer surface of the electrically heated catalyst device.

### CROSS-REFERENCE TO RELATED APPLICATIONS

This application is based upon and claims the benefit of priority from Japanese Patent Application No. 2024-059183, filed on Apr. 1, 2024, the entire contents of which are incorporated herein by reference.

### BACKGROUND

### 1. Field

The present disclosure relates to an engine compartment structure for a vehicle.

### 2. Description of Related Art

An exhaust pipe for an engine disclosed in Japanese Laid-Open Patent Publication No. 2011-132870 includes an electrically heated catalyst device and a waste heat recovery device, which are disposed at intermediate locations along the exhaust pipe. The electrically heated catalyst device includes a catalyst support and a catalyst. The catalyst support generates heat by being energized. The catalyst is supported on the catalyst support. The waste heat recovery device recovers the exhaust gas flowing out of the electrically heated catalyst device. The waste heat recovery device heats the coolant of the engine by the heat of the recovered exhaust gas.

In the prior art, such as the above-mentioned publication, the electrically heated catalyst device included in the exhaust pipe emits radiant heat outward from its outer circumferential surface. While the prior art utilizes the heat of the exhaust gas discharged from the electrically heated catalyst device, it does not consider the utilization of the radiant heat emitted from the device itself. Therefore, the prior art leaves room for improvement in terms of effectively utilizing the radiant heat of the electrically heated catalyst device.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an engine compartment structure for a vehicle includes an engine disposed in an engine compartment of a vehicle, a dashboard panel that separates the engine compartment and a passenger compartment from each other, an exhaust pipe that extends from the engine toward the dashboard panel, and a flow passage forming member in which a flow passage is defined. A heating medium flows through the flow passage. A part of the exhaust pipe between the engine and the dashboard panel is formed by an electrically heated catalyst device in which a catalyst is supported by a catalyst support that generates heat when energized. The flow passage forming member is located between the engine and the dashboard panel. A part of an outer surface of the flow passage forming member faces an outer surface of the electrically heated catalyst device.

Other features and aspects will be apparent from the following detailed description, the drawings, and the claims.

### BRIEF DESCRIPTION OF THE DRAWINGS

FIG. 1 is a side view schematically showing an example of the arrangement of components in an engine compartment.

FIG. 2 is a top view schematically showing the example of the arrangement of the components in the engine compartment.

FIG. 3 is an explanatory diagram showing a coolant circuit.

FIG. 4 is an explanatory diagram showing an oil circuit.

FIG. 5 is an explanatory diagram showing a vehicle according to a modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An engine compartment structure for a vehicle according to an embodiment will now be described, in which a plug-in hybrid electric vehicle 10 is used as an example. In the present embodiment, directional terms such as upper, lower, left, right, front, and rear are defined based on the orientation of the vehicle 10. Specifically, the front direction corresponds to the direction the driver faces when seated in the driver's seat of the vehicle 10.

### Overall Configuration

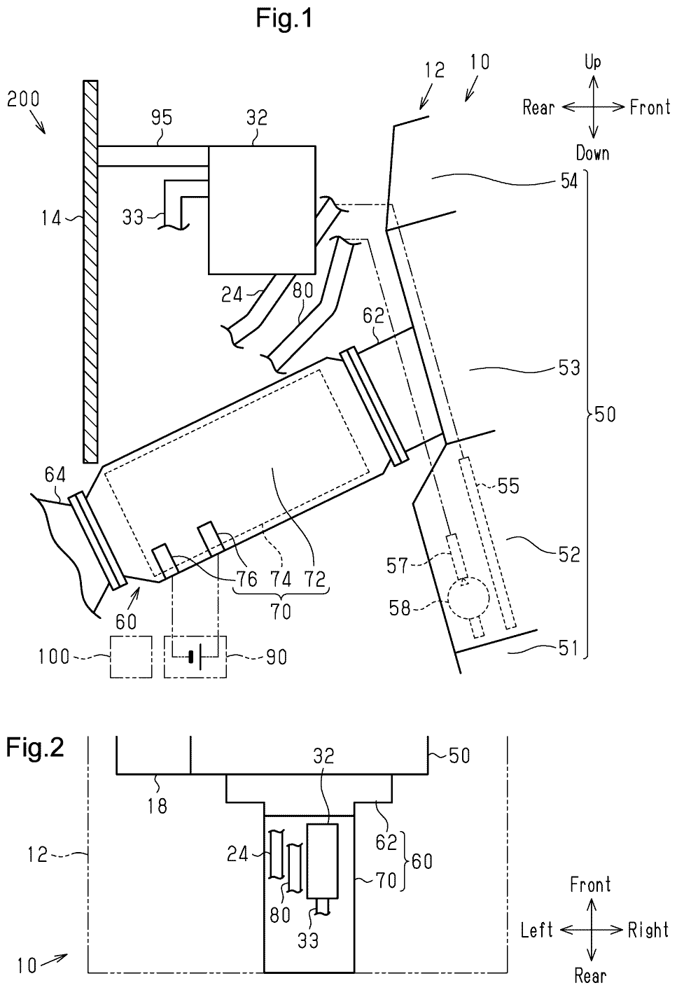

As shown in FIGS. 1 and 2, the vehicle 10 includes an engine compartment 12. The engine compartment 12 is located in a front portion of the vehicle 10 with respect to a passenger compartment 200. The engine compartment 12 is a space defined by a dashboard panel 14, fender panels, and the like. The dashboard panel 14 separates the passenger compartment 200 and the engine compartment 12 at the rear end of the engine compartment 12. The fender panels form left and right outer walls of the front portion of the vehicle 10.

As shown in FIG. 2, the vehicle 10 includes a drive unit 18. The drive unit 18 is disposed in the engine compartment 12. The drive unit 18 includes two motors and a power transmission mechanism. The two motors are drive sources of the vehicle 10. The two motors transmit and receive electric power to and from a battery (not shown). The battery can be charged by an external power supply.

As shown in FIG. 1, the vehicle 10 includes an engine 50. The engine 50 is disposed adjacent to the drive unit 18 in the engine compartment 12. The engine 50 is a drive source of the vehicle 10. The engine 50 includes an oil pan 51, a cylinder block 52, a cylinder head 53, and a head cover 54. The oil pan 51, the cylinder block 52, the cylinder head 53, and the head cover 54 are stacked in that order from bottom to top. The oil pan 51 stores lubricating oil. The cylinder block 52 defines cylinders. The cylinder head 53 defines intake ports for introducing intake air into the respective cylinders and exhaust ports for discharging exhaust gas from the respective cylinders. The engine 50 includes a water jacket 55. The water jacket 55 is a passage for coolant defined in the cylinder block 52 and the cylinder head 53. The coolant is a heating medium. The engine 50 includes an oil passage 57. The oil passage 57 is a passage for lubricating oil from the interior of the oil pan 51 to various parts of the engine 50. The lubricating oil is a heating medium. FIG. 1 schematically shows the water jacket 55 and the oil passage 57.

As shown in FIG. 4, the oil passage 57 is connected to an object to be lubricated 40 outside the engine 50. An example of the object to be lubricated 40 is a forced-induction device that pressurizes the intake air supplied to each cylinder of the engine 50. Specifically, the housing of the forced-induction device defines a passage. The passage in the forced-induction device is connected to the oil passage 57 via another pipe or the like.

As shown in FIG. 1, the vehicle 10 includes an exhaust pipe 60. The exhaust pipe 60 extends from the engine 50 toward the dashboard panel 14 as a whole. The exhaust pipe 60 includes an exhaust manifold 62, an electrically heated catalyst device (hereinafter, referred to as an EHC) 70, and a downstream pipe 64. The exhaust pipe 60 has a configuration in which these components are joined together.

The exhaust manifold 62 constitutes the most upstream section of the exhaust pipe 60. The exhaust manifold 62 is attached to a surface of the cylinder head 53 that faces the dashboard panel 14. The upstream side of the exhaust manifold 62 is branched in accordance with the number of the cylinders. The downstream side of the exhaust manifold 62 is a single pipe. Accordingly, the exhaust manifold 62 collects exhaust gases from individual cylinders into a single flow.

The EHC 70 is connected to an end of the exhaust manifold 62 on a side opposite to the cylinder head 53. The EHC 70 forms a part of the exhaust pipe 60. The EHC 70 includes a case 72, a catalyst support 74, and two electrodes 76. The case 72 has a cylindrical shape. The catalyst support 74 is located in the case 72. The catalyst support 74 is formed of a material that becomes an electrical resistance and generates heat when energized. For example, silicon carbide can be used as such a material. The catalyst support 74 has a cylindrical outer shape. The interior of the catalyst support 74 is a honeycomb-shaped passage. The catalyst support 74 supports a catalyst such as platinum, palladium, and rhodium, for example. The two electrodes 76 are connected to the outer circumferential surface of the catalyst support 74 and protrude to the outside of the case 72. The electrodes 76 are connected to a power unit 90 mounted on the vehicle 10 via a power line. When the electrodes 76 are energized, the catalyst support 74 generates heat. When the catalyst support 74 generates heat, the catalyst is heated and activated. The EHC 70 is located between the engine 50 and the dashboard panel 14 together with the exhaust manifold 62. The EHC 70 extends substantially in the front-rear direction. The rear end of the EHC 70 is located at substantially the same position as the dashboard panel 14.

The downstream pipe 64 is connected to an end of the EHC 70 opposite to the exhaust manifold 62. The downstream pipe 64 is located rearward of the engine compartment 12. The downstream pipe 64 extends below the dashboard panel 14 and reaches the area beneath the passenger compartment 200.

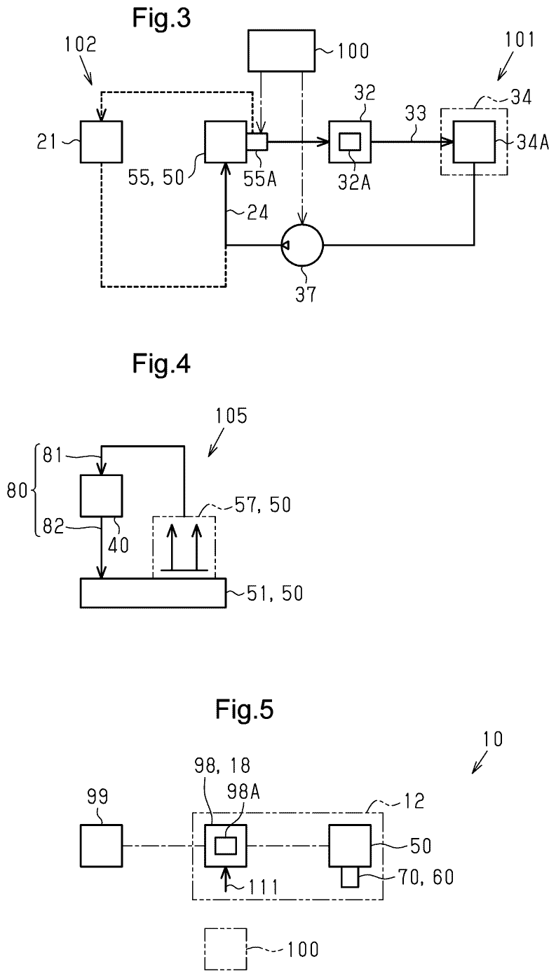

As shown in FIG. 3, the vehicle 10 is provided with an air conditioner 34. The air conditioner 34 adjusts the temperature of the passenger compartment 200. The air conditioner 34 includes a fan that sends air to the passenger compartment 200, and a heater core 34A for heating.

### Coolant Circuits

The vehicle 10 include coolant circuits. The coolant circuits are circulatory systems for coolant within the vehicle 10. The coolant circuits include two coolant circuits. As shown in FIG. 3, a first coolant circuit 101 extends from the water jacket 55 of the engine 50 to the heater core 34A, and returns from the heater core 34A to the water jacket 55. In FIG. 3, the path of the first coolant circuit 101 is indicated by solid arrows. The first coolant circuit 101 includes an electric pump 37, which is disposed along the return path from the heater core 34A to the water jacket 55 and drives the circulation of coolant. A second coolant circuit 102 extends from the water jacket 55 of the engine 50 to a radiator 21, and returns from the radiator 21 to the water jacket 55. In FIG. 3, the path of the second coolant circuit 102 is indicated by a dashed arrow. A downstream section of the second coolant circuit 102 merges into the first coolant circuit 101 at an intermediate section along the return path from the heater core 34A to the water jacket 55. After merging, the downstream section of the second coolant circuit 102 shares a common flow passage with a downstream section of the first coolant circuit 101. Although not illustrated, the second coolant circuit 102 includes a mechanical pump, which is driven by the operation of the crankshaft of the engine 50 to circulate coolant. A switching valve 55A for switching the flow passage of coolant is positioned at the outlet of the water jacket 55.

As shown in FIG. 3, the vehicle 10 includes a heating device 32 and a connection pipe 33. The heating device 32 and the connection pipe 33 form part of the section of the first coolant circuit 101 extending from the water jacket 55 to the heater core 34A. The heating device 32 has an internal passage that defines a flow passage for flow of coolant. Similarly, the connection pipe 33 has an internal passage that allows coolant to flow. The internal flow passage of the heating device 32 is connected to the heater core 34A via the connection pipe 33. The heating device 32 incorporates a heater 32A capable of heating the internal flow passage. The heater 32A is connected to the power unit 90 via a power line (not shown). The heating device 32 and the connection pipe 33 are flow passage forming members. The heating device 32 and the connection pipe 33 are made of metal.

As shown in FIG. 1, the heating device 32 is located between the engine 50 and the dashboard panel 14 and above the EHC 70. At this position, the heating device 32 is fixed to the dashboard panel 14 by a bracket 95. In the present embodiment, the heating device 32 is located within the range of the EHC 70 in both the front-rear direction and the left-right direction as shown in FIG. 2. Specifically, the heating device 32 is located directly above the EHC 70. The heating device 32 is located at a position shifted in the front-rear direction with respect to the connection pipe 33. The heating device 32 is located at a position shifted in the left-right direction with respect to a coolant pipe 24 and an oil pipe 80, which will be discussed below. As shown in FIGS. 1 and 2, there is no other component between the lower surface of the heating device 32 and the EHC 70. In other words, the lower surface of the heating device 32 faces the outer surface of the EHC 70 without any intervening component. Similarly to the heating device 32, a part of the connection pipe 33 is located between the engine 50 and the dashboard panel 14 and above the EHC 70. A part of the connection pipe 33 is located directly above the EHC 70. No other component is present between the EHC 70 and the part of the connection pipe 33 located directly above the EHC 70. In other words, a part of the outer surface of the connection pipe 33 faces the outer surface of the EHC 70 without any intervening component.

As shown in FIG. 3, the vehicle 10 includes the coolant pipe 24. The coolant pipe 24 forms part of the section of the first coolant circuit 101 that returns from the heater core 34A to the water jacket 55. The coolant pipe 24 thus has an internal passage that allows coolant to flow. The coolant pipe 24 is connected to the inlet of the water jacket 55. The coolant pipe 24 is a flow passage forming member. The coolant pipe 24 is made of metal.

As shown in FIG. 1, a part of the coolant pipe 24 is located between the engine 50 and the dashboard panel 14 and above the EHC 70. In the present embodiment, a part of the coolant pipe 24 is located within the range of the EHC 70 in both the front-rear direction and the left-right direction as shown in FIG. 2. In other words, the part of the coolant pipe 24 is located directly above the EHC 70. The coolant pipe 24 is located at a position shifted in the left-right direction with respect to the oil pipe 80, which will be discussed below. As shown in FIGS. 1 and 2, no other component is present between the EHC 70 and the part of the coolant pipe 24 located directly above the EHC 70. A part of the outer surface of the coolant pipe 24 thus faces the outer surface of the EHC 70 without any intervening component.

### Oil Circuit

As shown in FIG. 4, the vehicle 10 includes an oil circuit 105. The oil circuit 105 is, for example, a circulatory system for lubricating oil related to the engine 50. The oil circuit 105 extends from the oil pan 51 through the oil passage 57 of the engine 50 to the object to be lubricated 40 and returns from the object to be lubricated 40 to the oil pan 51. As shown in FIG. 1, for example, the oil circuit 105 includes an electric pump 58 that circulates lubricating oil, in addition to the mechanical pump driven by the crankshaft of the engine 50. FIG. 1 schematically shows the electric pump 58.

As shown in FIG. 4, the vehicle 10 includes the oil pipe 80 at an intermediate location along the oil circuit 105. The oil pipe 80 includes a first oil pipe 81 and a second oil pipe 82. A flow passage through which lubricating portion flows is defined inside the first oil pipe 81 and the second oil pipe 82. The first oil pipe 81 is connected to the oil passage 57 of the engine 50 and the object to be lubricated 40. The second oil pipe 82 is connected to the object to be lubricated 40 and the interior of the oil pan 51. In this manner, the oil pipe 80 is connected to the interior of the oil pan 51. The oil pipe 80 is a flow passage forming member. The oil pipe 80 is made of metal.

As shown in FIG. 1, a part of the oil pipe 80 is located between the engine 50 and the dashboard panel 14 and above the EHC 70. In the present embodiment, a part of the oil pipe 80 is located within the range of the EHC 70 in both the front-rear direction and the left-right direction as shown in FIG. 2. In other words, the part of the oil pipe 80 is located directly above the EHC 70. As shown in FIGS. 1 and 2, no other component is present between the EHC 70 and the part of the oil pipe 80 located directly above the EHC 70. In other words, a part of the outer surface of the oil pipe 80 faces the outer surface of the EHC 70 without any intervening component.

### Control Configuration

As shown in FIG. 1, the vehicle 10 includes a controller 100. The controller 100 controls various parts of the vehicle 10. For example, the controller 100 controls the two motors in the drive unit 18 and the engine 50. The controller 100 intermittently stops the engine 50 in accordance with the traveling state of the vehicle 10. The controller 100 controls the power unit 90. The controller 100 controls energization of the EHC 70 by the power unit 90. The controller 100 energizes the EHC 70 for a specified time, for example, one minute, prior to starting the engine 50. Further, as shown in FIG. 3, the controller 100 controls the switching valve 55A and the electric pump 37 of the first coolant circuit 101. When energizing the EHC 70, the controller 100 controls the switching valve 55A to circulate coolant in the first coolant circuit 101 and drives the electric pump 37 in the first coolant circuit 101. As shown in FIG. 1, the controller 100 controls the electric pump 58 of the oil circuit 105. When energizing the EHC 70, the controller 100 drives the electric pump 58 of the oil circuit 105.

### Operation of the Embodiment

When the controller 100 energizes the EHC 70, the catalyst support 74 generates heat. Then, the catalyst is activated before the engine 50 is started. When the catalyst support 74 generates heat due to the energization of the EHC 70, the heat reaches the outside of the case 72 of the EHC 70. That is, the EHC 70 emits radiant heat to its surroundings. In the present embodiment, a part of the outer surface of each flow passage forming member faces the outer surface of the EHC 70 without any intervening component. Accordingly, the radiant heat of the EHC 70 reaches each flow passage forming member without being obstructed by any other component.

### Advantages of the Embodiment

(1) As described in the operation of the present embodiment, the configuration of the present embodiment allows the radiant heat of the EHC 70 to reach the respective flow passage forming members without being obstructed by any other component. This heats the heating medium inside each of the flow passage forming members. As described above, the configuration of the present embodiment efficiently utilizes the radiant heat of the EHC 70 to heat the heating media.

(2) In the present embodiment, each of the flow passage forming members is located above the EHC 70. The air around the EHC 70 heated by the radiant heat of the EHC 70 tends to accumulate in the upper portion of the engine compartment 12. Therefore, when the respective flow passage forming members are disposed above the EHC 70 as in the present embodiment, the respective flow passage forming members, which have been warmed, are prevented from being cooled by the surrounding cold air.

(3) In the present embodiment, one of the multiple flow passage forming members is the heating device 32, which incorporates the heater 32A. The heating device 32 heats the coolant flowing through the internal flow passage of the heating device 32 using both heat of the heater 32A and the radiant heat of the EHC 70. With this configuration of the present embodiment, it is possible to quickly raise the temperature of the coolant in the internal flow passage, and to bring the coolant to a required temperature while limiting the amount of heating by the heater 32A. These contribute to reduction in the power consumption of the heating device 32.

(4) In the present embodiment, one of the multiple flow passage forming members is the coolant pipe 24, which is connected to the water jacket 55 of the engine 50. Therefore, when the EHC 70 is energized before the engine 50 is started, the coolant in the coolant pipe 24 is heated by the radiant heat of the EHC 70. Accordingly, warmed coolant is supplied to the water jacket 55 immediately after the start of the engine 50.

(5) In the present embodiment, one of the multiple flow passage forming members is the oil pipe 80, which is connected to the oil pan 51 and the object to be lubricated 40. Therefore, when the EHC 70 is energized before the engine 50 is started, the lubricating oil in the oil pipe 80 is heated by the radiant heat of the EHC 70. Accordingly, warmed lubricating oil is supplied to the engine 50 and the object to be lubricated 40 immediately after the start of the engine 50.

(6) In the present embodiment, the multiple flow passage forming members through which different heating media to be heated flow are arranged inside the engine compartment 12 so as to satisfy the following arrangement requirement. The arrangement requirement is that at least a part of the outer surface of each flow passage forming member faces the outer surface of the EHC 70 without any intervening component. This configuration of the present embodiment allows multiple flow passage forming members to be heated by the radiant heat of the single EHC 70. Therefore, the radiant heat of the EHC 70 is utilized highly efficiently. Regarding multiple flow passage forming members through which different heating media flow, the following can be stated. For example, even if heating media of the same type flow through two flow passage forming members, those flow passage forming members correspond to the multiple flow passage forming members through which different heating media to be heated flow, if the flow passage forming members are not continuously connected to each other and are installed independently. In other words, the multiple flow passage forming members through which different heating media flow are regarded as distinct types of flow passage forming members.

### Modifications

The above-described embodiment may be modified as follows. The above-described embodiment and the following modifications can be combined as long as the combined modifications remain technically consistent with each other.

The section of the coolant circuits formed by the coolant pipe 24 is not limited to the example in the above-described embodiment. The coolant pipe 24 may form a portion other than the downstream section of the first coolant circuit 101. Both the first coolant circuit 101 and the second coolant circuit 102 are configured to pass through the water jacket 55. Therefore, if the coolant pipe 24 forms any portion of the first coolant circuit 101 and the second coolant circuit 102, the coolant pipe 24 is considered connected to the water jacket 55.

The configuration of the coolant circuits is not limited to the example in the above-described embodiment. For example, the coolant circuit may have any configuration as long as each coolant circuit passes through components to which the coolant needs to be supplied, such as the water jacket 55 and the air conditioner 34.

The configuration of the oil circuit 105 is not limited to the example in the above-described embodiment. The oil circuit 105 does not necessarily need to include the object to be lubricated 40 at an intermediate location. For example, the engine 50 may be configured as a dry sump system. When the engine 50 is configured as a dry sump system, the volume of the oil pan 51 located at the bottom of the engine 50 is reduced, and the vehicle 10 includes an oil tank separate from the engine 50. In a case in which such a dry sump system is employed, the oil circuit 105 may be configured to include a path through which lubricating oil moves between the engine 50 and the oil tank. An intermediate portion in the oil circuit 105 may be formed by the oil pipe 80. Even in this case, the oil pipe 80 is connected to the interior of the oil pan 51 of the engine 50. In this manner, the oil circuit 105 may be modified as long as its intermediation portion passes through the oil pan 51. The oil pipe 80 may be modified as long as it is connected to the interior of the oil pan 51 of the engine 50.

The material of each flow passage forming member is not limited to the example in the above-described embodiment. The material of the flow passage forming members may be any material as long as the heating media inside can be heated by the radiant heat of the EHC 70. An appropriate material may be employed for each flow passage forming member according to the use of the flow passage forming member.

The arrangement of the flow passage forming members is not limited to the example in the above-described embodiment. For example, the heating device 32 may be disposed outside the EHC 70 in both the front-rear direction and the left-right direction of the vehicle 10. The same applies to the other flow passage forming members. Additionally, the portion of each flow passage forming member that faces the EHC 70 may be located below, rather than above, the EHC 70. Each flow passage forming member may be arranged at the same height as the EHC 70, located side by side with the EHC 70 in the left-right direction. The arrangement of each flow passage forming member can be changed as long as a part of the outer surface of the flow passage forming member faces the outer surface of the EHC 70. An object may be present between the flow passage forming member and the EHC 70, provided that the object does not completely block the radiant heat emitted from the EHC 70. Additionally, the radiant heat from the EHC 70 may be transferred to the flow passage forming members as the air heated by the radiant heat of the EHC 70 circulates around the object and reaches the flow passage forming members.

The vehicle on-board components forming the flow passage forming members are not limited to the examples in the above-described embodiment. Each flow passage forming member may have any configuration with a flow passage through which heating medium flows. For example, such a flow passage forming member may be connected to the drive unit 18.

The number of the flow passage forming members disposed in the engine compartment 12 is not limited to the example in the above-described embodiment. One or more of the multiple flow passage forming members described in the above-described embodiment may be omitted depending on the arrangement, configuration, type, and the like of the vehicle on-board components to be connected to the flow passage forming members. Further, as described in the modifications, a flow passage forming member different from those described in the example in the above-described embodiment may be disposed in the engine compartment 12 as long as one or more flow passage forming members are disposed in the engine compartment 12.

It is not essential that there be multiple flow passage forming members facing the outer surface of the EHC 70 as long as one or more flow passage forming members are present in the engine compartment 12.

The heating media are not limited to the examples in the above-described embodiment. The heating media may be, for example, air. The heating media may be any fluids that transfer heat.

The overall configuration of the vehicle 10 is not limited to the example in the above-described embodiment. For example, the vehicle 10 may be a hybrid electric vehicle that is not charged by an external power supply. The number of motors serving as the drive sources of the vehicle 10 may be changed from the example in the above-described embodiment. The vehicle 10 does not necessarily need to include motors as drive sources. Further, as shown in FIG. 5, the vehicle 10 may include a transmission 98. For example, the transmission 98 may be provided as part of the drive unit 18 that includes a motor. The transmission 98 incorporates a hydraulic circuit 98A that actuates gear shifting. The controller 100 actuates gear shifting of the transmission 98 in accordance with the traveling state of the vehicle 10. As the gear shift position of the transmission 98 changes, the gear ratio of the transmission 98 is also altered. The transmission 98 is disposed in the engine compartment 12 together with the engine 50. Based on the currently set gear ratio, the transmission 98 converts the driving force from the engine 50 and transmits it to drive wheels 99 of the vehicle 10. In a case in which the transmission 98 is provided in the vehicle 10, the vehicle 10 may include an oil pipe 111 connected to the hydraulic circuit 98A of the transmission 98. A flow passage through which hydraulic oil flows is defined inside the oil pipe 111. In other words, the oil pipe 111 forms a flow passage forming member. The hydraulic oil is a heating medium. The oil pipe 111 is made of, for example, metal. The oil pipe 111 may be disposed in the engine compartment 12 so as to face the outer surface of the EHC 70. For example, a part of the outer surface of the oil pipe 111 may face the outer surface of the EHC 70 without any intervening component. This configuration allows the hydraulic oil in the oil pipe 111 to be heated by radiant heat of the EHC 70. Therefore, this configuration is suitable for supplying warmed hydraulic oil to the transmission 98.

In the above modification, the transmission 98 may also be a type in which gear shifting is actuated manually by the driver.

The timing of energizing the EHC 70 is not limited to the example in the above- described embodiment. For example, the EHC 70 may be energized during the operation of the engine 50 such as immediately after the start of the engine 50. The EHC 70 may be energized as needed, at appropriate times.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An engine compartment structure for a vehicle, comprising:
an engine disposed in an engine compartment of a vehicle;
a dashboard panel that separates the engine compartment and a passenger compartment from each other;
an exhaust pipe that extends from the engine toward the dashboard panel; and
a flow passage forming member in which a flow passage is defined, a heating medium flowing through the flow passage, wherein
a part of the exhaust pipe between the engine and the dashboard panel is formed by an electrically heated catalyst device in which a catalyst is supported by a catalyst support that generates heat when energized,
the flow passage forming member is located between the engine and the dashboard panel, and
a part of an outer surface of the flow passage forming member faces an outer surface of the electrically heated catalyst device.

2. The engine compartment structure for the vehicle according to claim 1, wherein the flow passage forming member is located above the electrically heated catalyst device.

3. The engine compartment structure for the vehicle according to claim 1, wherein the flow passage forming member is a heating device in which a flow passage through which a coolant can flow is defined, the heating device incorporating a heater capable of heating the flow passage.

4. The engine compartment structure for the vehicle according to claim 1, wherein the flow passage forming member is a coolant pipe that is connected to a water jacket defined in the engine, the coolant pipe allowing a coolant to flow therethrough.

5. The engine compartment structure for the vehicle according to claim 1, wherein the flow passage forming member is an oil pipe that is connected to an interior of an oil pan of the engine, the oil pipe allowing a lubricating oil to flow therethrough.

6. The engine compartment structure for the vehicle according to claim 1, further comprising
a transmission that is disposed in the engine compartment and converts a driving force from the engine and transmit the converted driving force to a drive wheel of the vehicle,
wherein the flow passage forming member is an oil pipe that is connected to the transmission, the oil pipe allowing a hydraulic oil to flow therethrough.

7. The engine compartment structure for the vehicle according to claim 1, wherein the flow passage forming member is one of the flow passage forming members through which different heating media to be heated flow.

8. The engine compartment structure for the vehicle according to claim 7, wherein the flow passage forming members are located above the electrically heated catalyst device.

9. The engine compartment structure for the vehicle according to claim 7, wherein one of the flow passage forming members is a heating device in which a flow passage through which a coolant can flow is defined, the heating device incorporating a heater capable of heating the flow passage.

10. The engine compartment structure for the vehicle according to claim 7, wherein one of the flow passage forming members is a coolant pipe that is connected to a water jacket defined in the engine, the coolant pipe allowing a coolant to flow therethrough.

11. The engine compartment structure for the vehicle according to claim 7, wherein one of the flow passage forming members is an oil pipe that is connected to an interior of an oil pan of the engine, the oil pipe allowing a lubricating oil to flow therethrough.

12. The engine compartment structure for the vehicle according to claim 7, further comprising a transmission that is disposed in the engine compartment and converts a driving force from the engine and transmit the converted driving force to a drive wheel of the vehicle,
wherein one of the flow passage forming members is an oil pipe that is connected to the transmission, the oil pipe allowing a hydraulic oil to flow therethrough.
